(19) United States
(12) Patent Application Publication
(10) Pub. No.: US 2015/0309155 A1
(43) Pub. Date: Oct. 29, 2015

(54) Method and Apparatus for Determining the Position Using Radio Signals and Atmospheric Pressure

(71) Applicants: Fabio Belloni, Espoo (FI); Antti Kainulainen, Espoo (FI); Ville Ranki, Espoo (FI)

(72) Inventors: Fabio Belloni, Espoo (FI); Antti Kainulainen, Espoo (FI); Ville Ranki, Espoo (FI)

(73) Assignee: Nokia Corporation, Espoo (FI)

(21) Appl. No.: 13/637,644

(22) PCT Filed: Mar. 30, 2010
(86) PCT No.: PCT/IB2010/051388

§ 371 Date: Aug. 5, 2013

(51) Int. Cl. G01S 5/02; H01Q 21/28; H04W 64/00

(52) U.S. Cl. CPC G01S 5/0257; H04W 64/00; H01Q 21/28

(57) ABSTRACT

A method comprising: receiving signals associated with multiple antenna elements; determining constraint information based upon an atmospheric pressure measurement taken at an apparatus; and using the received signals and the constraint information to determine the position of the apparatus.

### FIELD OF THE INVENTION

Embodiments of the present invention relate to positioning. In particular, they relate to a method, an apparatus, a module, a chipset or a computer program for positioning using radio signals.

### BACKGROUND TO THE INVENTION

There are a number of known techniques for determining the position of an apparatus using radio frequency signals. Some popular techniques relate to use of the Global Positioning System (GPS), in which multiple satellites orbiting Earth transmit radio frequency signals that enable a GPS receiver to determine its position. However, GPS is often not very effective in determining an accurate position indoors.

Some non-GPS positioning techniques enable an apparatus to determine its position indoors. However, some of these techniques do not result in an accurate position being determined, and others are too complex for use simply in a portable apparatus. For example, the amount of processing power required to perform the technique may be impractical to provide in a portable apparatus, which may need to perform concurrent functions.

### BRIEF DESCRIPTION OF VARIOUS EMBODIMENTS OF THE INVENTION

According to various embodiments of the invention there is provided a method comprising: receiving signals associated with multiple antenna elements; determining constraint information based upon an atmospheric pressure measurement taken at an apparatus; and using the received signals and the constraint information to determine the position of the apparatus.

According to various embodiments of the invention there is provided an apparatus comprising: at least one processor; and at least one memory including computer program code the at least one memory and the computer program code configured to, with the at least one processor, cause the apparatus at least to perform: determining constraint information based upon an atmospheric pressure measurement taken at an apparatus; and using received signals associated with multiple antenna elements and the constraint information to determine the position of the apparatus.

According to various embodiments of the invention there is provided an apparatus comprising: means for receiving signals associated with multiple antenna elements; means for determining constraint information based upon an atmospheric pressure measurement taken at an apparatus; means for using the received signals and the constraint information to determine the position of the apparatus.

According to various embodiments of the invention there is provided a computer program which when loaded into a processor enables the processor to: determine constraint information based upon an atmospheric pressure measurement taken at an apparatus; and use received signals associated with multiple antenna elements and the constraint information to determine the position of the apparatus.

According to various embodiments of the invention there is provided an apparatus comprising: a pressure sensor configured to take a local atmospheric pressure measurement; a transmitter configured to transmit a signal for positioning the apparatus, the signal encoding the local atmospheric pressure measurement.

### BRIEF DESCRIPTION OF THE DRAWINGS

For a better understanding of various embodiments of the present invention reference will now be made by way of example only to the accompanying drawings in which:

FIG. 1 illustrates an apparatus receiving radio signals from a transmitter;

FIG. 2 is a schematic of a receiver apparatus when diversity reception is used;

FIG. 3 is a flow diagram of a method of estimating a position;

FIG. 4 illustrates a schematic for estimating the position using pressure difference as a constraint;

FIG. 5 is a schematic illustration of a transmitter apparatus when diversity reception is used;

FIG. 6 is a schematic illustration of a system for providing atmospheric pressure measurements;

FIG. 7 is a schematic illustration of a system for providing an atmospheric pressure model; and

FIG. 8 schematically illustrates a system in which diversity transmission is used.

### DETAILED DESCRIPTION OF VARIOUS EMBODIMENTS OF THE INVENTION

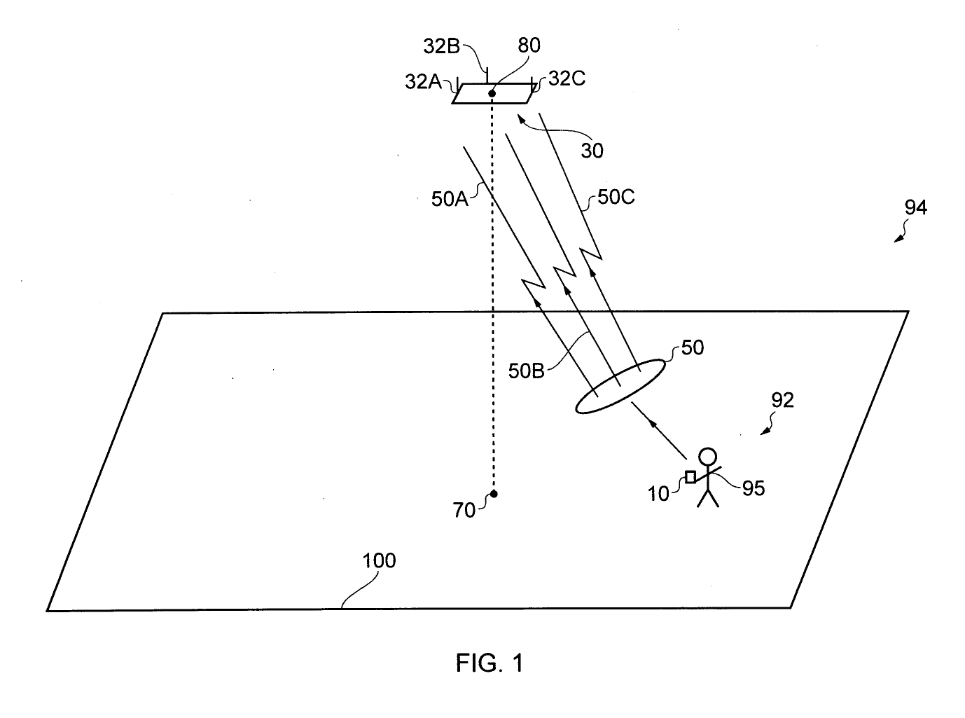

FIG. 1 illustrates a person 92 (carrying a mobile radio communications apparatus 10) at a position 95 on a floor 100 of a building 94. The building 94 could be, for example, a shopping center or a conference center.

A base station receiver apparatus 30 is positioned at a location 80 of the building 94. In the illustrated example, the location 80 is on the ceiling of the building 94 (i.e. the overhead interior surface) but in other implementations the receiver may be placed elsewhere such as on a wall.

The location 80 is directly above the point denoted with the reference numeral 70 on the floor 100 of the building. The receiver apparatus 30 is for enabling the position of the apparatus 10 to be determined although that is not necessarily the only function provided by the receiver apparatus 30. For example, the receiver apparatus 30 may be part of a transceiver for providing wireless internet access to users of apparatuses 10, for example, via wireless local area network (WLAN) radio signals.

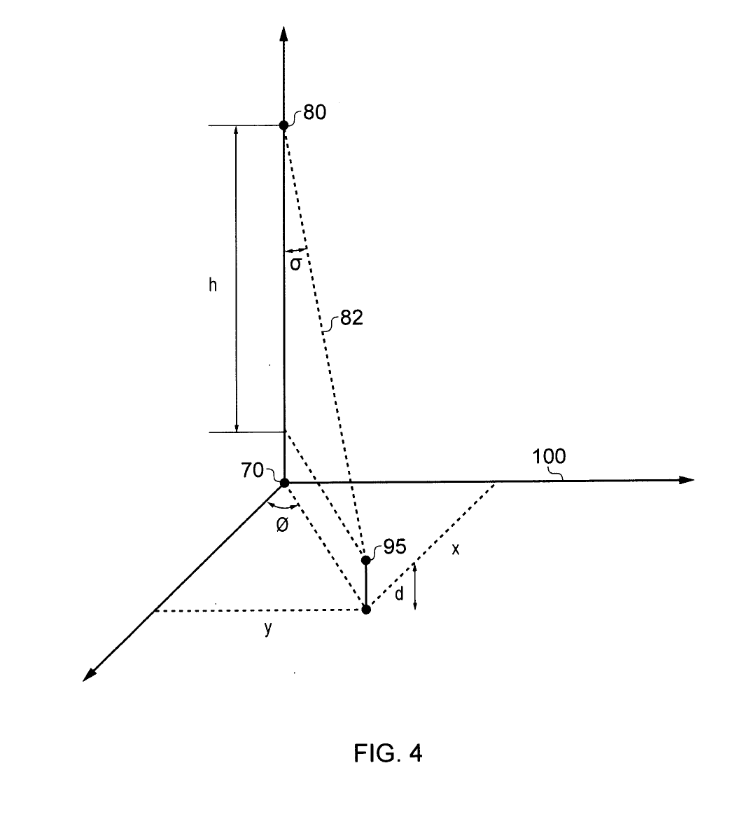

The position 95 of the person 92 is defined by specifying a position along a bearing 82 (illustrated in FIG. 4) which runs from the location 80 of the receiver apparatus 30 through the location 95 of the apparatus 10, The bearing 82 is defined by an elevation angle 8 and an azimuth angle φ.

The mobile apparatus 10 may, for example, be a hand portable electronic device such as a mobile radiotelephone. The apparatus 10 may transmit radio signals 50 periodically as beacons.

The radio signals may, for example, have a transmission range of 100 meters or less. For example, the radio frequency signals may be 802.11 wireless local area network (WLAN) signals, Bluetooth signals, Ultra wideband (UWB) signals or Zigbee signals.

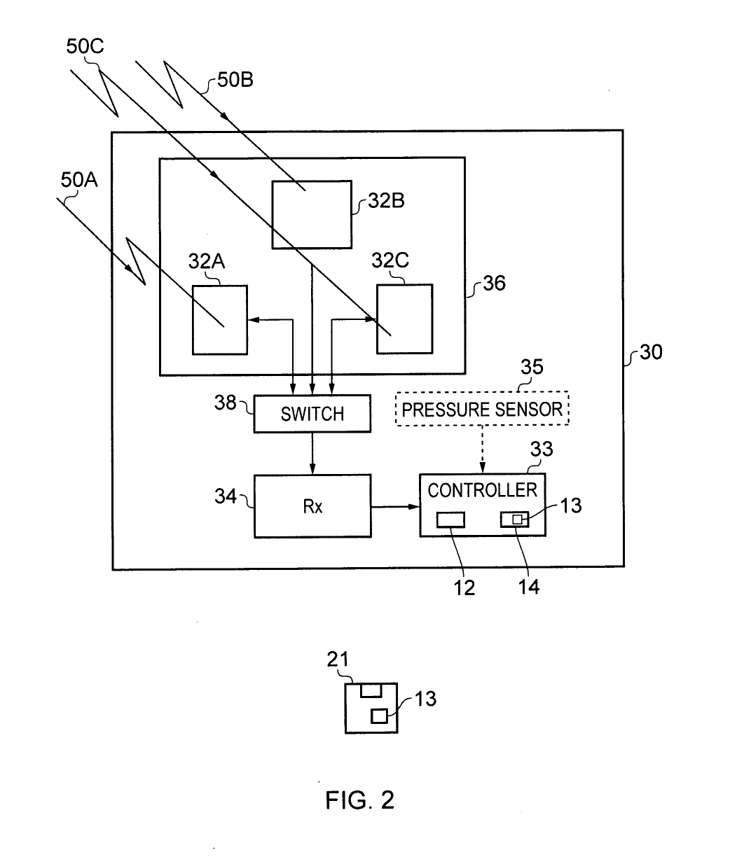

FIG. 2 schematically illustrates one example of the base station receiver apparatus 30. The receiver apparatus 30 comprises an antenna array 36 comprising a plurality of antenna elements 32A, 32B, 32C which receive respective radio signals 50A, 50B, 50C . . . transmitted from the mobile apparatus 10. The antenna array 28 is connected through switch 38 to receiver circuitry 34. The switch 38 may, for example, switch each antenna element 32 to the receiver circuitry 34 according to a defined sequence. The receiver circuitry 34 processes the received signals to obtain characteristics of the received signals 50. The receiver circuitry 34 provides an output to a controller 33.

The receiver circuitry 34 needs to obtain ‘displacement information’ from the received signals 50A, 50B, 50C that is dependent upon inter alia the relative displacements of the respective antenna elements 32A, 32B, 32C. In the example described in detail below, the displacement information includes phase information.

The receiver circuitry 34 may also be configured to demodulate the received signals.

For example, the receiver circuitry 34 may demodulate using I-Q modulation, also known as quadrature phase shift modulation. In this modulation technique, two orthogonal carrier waves (sine and cosine) are independently amplitude modulated to define a symbol. At the receiver circuitry 34, the amplitude of the two orthogonal carrier waves is detected as a complex sample and the closest matching symbol determined. It should be appreciated that an identical signal received at different antenna elements will be received with different phases and amplitudes because of the inherent phase characteristics of the antenna elements 32 when receiving from different directions and also because of the different times of flight for a signal 50 to each antenna element 32 from the transmitter apparatus 10. The inherent presence of this ‘time of flight’ information within the phases of the received signals 50 enables the received signals 50 to be processed, as described in more detail below, to determine the bearing 82 of the transmitter apparatus 10 from the receiver apparatus 30.

In the Figure only three different displaced antenna elements 32 are illustrated, although in actual implementations more antenna elements 32 may be used. For example 16 patch antenna elements could be distributed over the surface of a hemisphere. Three is the minimum number of radio signals required at the receiver apparatus 30 to be able to determine a bearing 82.

The apparatus 30 itself does not need to transmit to determine its position. Furthermore it alone may perform the processing necessary to determine a bearing 82 and to estimate, using the bearing and constraint information, the position of the apparatus 10 along the bearing 82.

The controller 33 may be any suitable type of processing circuitry. The controller 33 may be, for example, programmable hardware with embedded firmware. The controller 33 may be a single integrated circuit or a set of integrated circuits (i.e. a chipset). The controller 33 may also be a hardwired, application-specific integrated circuit (ASIC). In the illustrated example, the controller 33 may comprise a programmable processor 12 that interprets computer program instructions 13 stored in a memory 14.

The processor 12 is connected to write to and read from the memory storage device 14. The storage device 14 may be a single memory unit or a plurality of memory units.

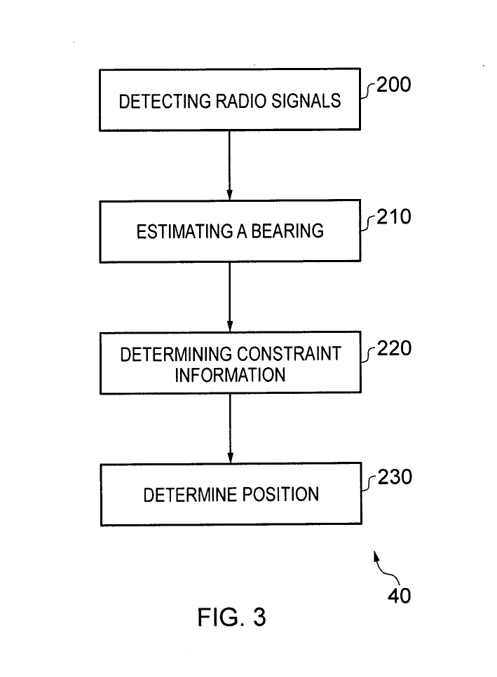

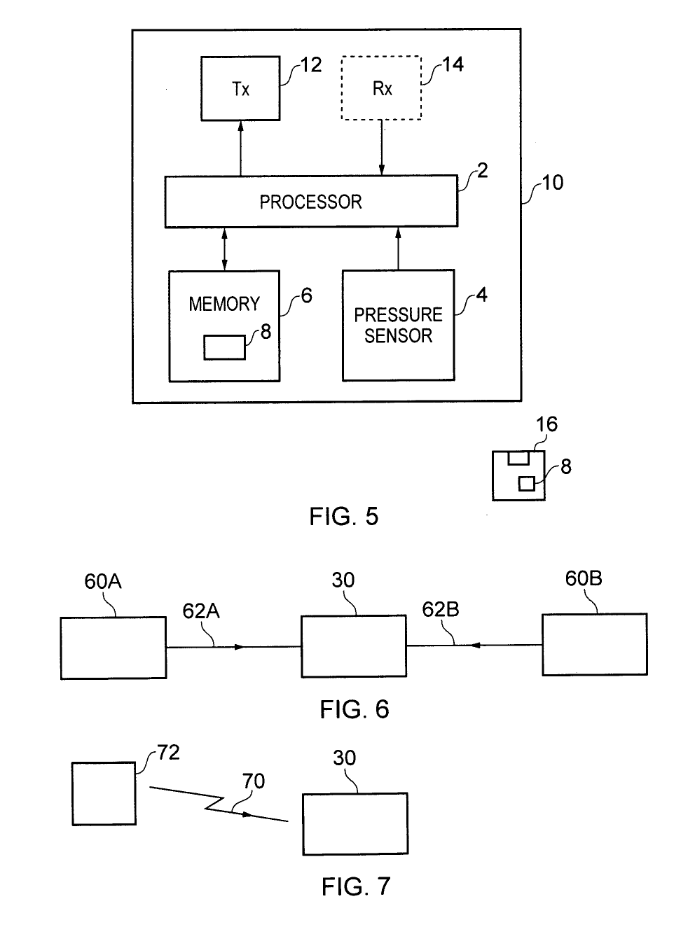

The storage device 14 may store computer program instructions 13 that control the operation of the apparatus 30 when loaded into processor 12. The computer program instructions 13 may provide the logic and routines that enables the apparatus to perform the method illustrated in FIG. 3 and FIG. 5.

The computer program may arrive at the apparatus 30 via any suitable delivery mechanism 21. The delivery mechanism 21 may be, for example, a computer-readable storage medium, a computer program product, a memory device, a record medium such as a CD-ROM or DVD, an article of manufacture that tangibly embodies the computer program 13. The delivery mechanism may be a signal configured to reliably transfer the computer program 13.

The apparatus 30 may propagate or transmit the computer program 13 as a computer data signal.

Although the memory 14 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

It will be appreciated by those skilled in the art that, for clarity, the controller 33 is described as being a separate entity to the receiver circuitry 34. However, it will be understood that the term controller 33 may relate not only to a main processor of an apparatus, but also processing circuitry included in a dedicated receiver chipset, and even to a combination of processing circuitry included in a main processor and a dedicated receiver chipset.

A chipset for performing embodiments of the invention may be incorporated within a module. Such a module may be integrated within the apparatus 30, and/or may be separable from the apparatus 30.

The apparatus 30 may in some but not necessarily all embodiments comprise a pressure sensor 35 for providing atmospheric pressure measurements to the controller 33. The atmospheric pressure measurements may be used with at atmospheric pressure measurement made at the transmitter apparatus 10 to generate the constraint information used to position of the transmitter apparatus 10 along the bearing 82.

The apparatus 30 comprises: the at least one processor 12; and the at least one memory 14 including the computer program code 13, the at least one memory 14 and the computer program code 13 configured to, with the at least one processor 12, cause the apparatus 30 at least to perform: determining constraint information based upon an atmospheric pressure measurement taken at an apparatus 10; and using received signals 50A, 50B, 50C associated with multiple antenna elements 32A, 32B, 32C and the constraint information to determine the position of the apparatus 10.

FIG. 3 illustrates a method for estimating the position of the apparatus 10. Various embodiments of the method of FIG. 3 will be described hereinafter. Although the method will be described in the context of diversity reception, it should be appreciated that it is also applicable to diversity transmission. In diversity transmission, multiple radio signals are sent from spatially diverse antenna elements. In diversity reception, a radio signal is received at spatially diverse antenna elements.

In the following it will be assumed that the respective spatially diverse received radio signals 50A, 50B, 50C are received at the receiver apparatus 30 as illustrated in FIGS. 1 and 2.

At block 200 of the method of FIG. 3, the receiver apparatus 30 detects radio signals 50 including first, second and third radio signals 50A, 50B, 50C.

At block 210, the controller 33 of the apparatus 30 uses the detected radio signals 50 to estimate a bearing 82 of the apparatus 10 from the first location 80.

The processor 12 obtains comparable complex samples (i.e. samples that represent same time instant) for the three respective radio signals 50A, 50B, 50C.

The processor 12 then estimates a bearing 82. One method of determining the bearing 82 is now described, but other methods are possible.

Once comparable complex samples (i.e. samples that represent same time instant) from each antenna element 32 are obtained the array output vector y(n) (also called as snapshot) can be formed at by the processor 12.

y(n)=[x₁,x₂, . . . ,x_{M}]^{T}, (1)

Where xᵢ is the complex signal received from the ith RX antenna element 32, n is the index of the measurement and M is the number of RX elements 32 in the array 36.

A Direction of Departure (DoD) can be estimated from the measured snapshots if the complex array transfer function a(φ,θ) of the RX array 36 is known, which it is from calibration data.

The simplest way to estimate putative DoDs is to use beamforming, i.e. calculate received power related to all possible DoDs. The well known formula for the conventional beamformer is

P_{BF}(φ,θ)=a*(φ,θ)\hat{R}a(φ,θ), (2)

Where,

$$\hat{R} = \frac{1}{N} {\sum }_{n = 1}^{N} y ( n ) {y}^{*} ( n )$$

is the sample estimate of the covariance matrix of the received signals, a(φ,θ) is the array transfer function related to the DoD(φ,θ), φ is the azimuth angle and θ is the elevation angle.

Once the output power of the beamformer P_{BF}(φ,θ) is calculated in all possible DoDs the combination of azimuth and elevation angles with the highest output power is selected to be the bearing 82.

The performance of the system depends on the properties of the antenna array 36. For example the array transfer functions a(φ,θ) related to different DoDs should have as low correlation as possible for obtaining unambiguous results.

Correlation depends on the individual radiation patterns of the antenna elements 32, inter element distances and array geometry. Also the number of array elements 32 has an effect on performance. The more elements 32 the array 36 has the more accurate the bearing estimation becomes. In minimum there should be at least 3 antenna elements 32 in planar array configurations but in practice 10 or more elements should provide good performance.

Next, at block 220 the processor 12 determines constraint information based upon an atmospheric pressure measurement taken at the mobile apparatus 10.

If the receiver apparatus 30 has a known height h_{ref} and the measured barometric pressure at the receiver apparatus 30 is p_{ref}, then the height hₘ of the mobile apparatus 10 can be expressed in terms of the measured barometric pressure pₘ at the mobile apparatus 10 and h_{ref} and p_{ref}.

hₘ=h_{ref}−H(p_{ref},pₘ)

The constraint information is a height hₘ or equivalent displacement which is dependent upon the taken pressure measurement pₘ.

For example

hₘ=h_{ref}−α⁻¹*Logₑ(pₘ/p_{ref})

which for small differences in height between hₘ and h_{ref} may alternatively be expressed as

hₘ=h_{ref}−α⁻¹((pₘ/p_{ref})−1)

where α is a temperature dependent constant gM/RT where g is gravitational acceleration, R is the universal gas constant, M is the molar mass of air and T is temperature.

An alternative expression uses the standard temperature lapse rate L and β=α*(T/L)

hₘ=h_{ref}+(T/L)*((pₘ/p_{ref})^{β}−1)

In the above examples, the receiver apparatus 30 has a known height h_{ref} and the measured barometric pressure at the receiver apparatus 30 is p_{ref}. However, in other examples the barometric pressure p_{ref} at the height h_{ref} may be a current measurement made by a different apparatus and communicated to the receiver apparatus 30 for determination of the position of the mobile apparatus 10.

FIG. 6 schematically illustrates a system for estimating a reference pressure, when the receiver apparatus 30 itself does not measure atmospheric pressure. In this example, the receiver apparatus 30 receives atmospheric pressure measurements 62A, 62B from one or more remote pressure sensors 60A, 60B.

The receiver apparatus 30 may select one of the received atmospheric pressure measurements 62A, 62B as the reference pressure. For example, it may select the pressure measurement from the closest pressure sensor.

Alternatively, the receiver apparatus 30 may use the multiple received atmospheric pressure measurements 62A, 62B to interpolate the reference pressure as the pressure at the location of the receiver apparatus 30.

In other examples the height hₘ of the mobile apparatus 10 is determined using the measured barometric pressure pₘ and an atmospheric pressure model which is updated as weather conditions change.

FIG. 7 schematically illustrates an embodiment in which the receiver apparatus 30 receives an atmosphere model 70 that has been transmitted from a remote server 72. The atmosphere model 70 may be a full model or an update to an existing model.

Returning to FIG. 3, next, at block 230 the processor 12 estimates a position of the apparatus 10 using the estimated bearing and the constraint information e.g. hₘ.

FIG. 4 also illustrates the bearing 82 from the location 80 of the receiver apparatus 30 to the location 95 of the transmitter apparatus 10, which has been estimated by the processor 12 following reception of the radio signals 50. The bearing 82 is defined by an elevation angle θ and an azimuth angle φ.

The processor 12 may estimate the position of the apparatus 10 relative to the location 80 of the receiver apparatus 30 in coordinates using the bearing (elevation angle θ, azimuth angle φ) and constraint information e.g. vertical displacement h (e.g. h_{ref}−hₘ) or its equivalent pressure difference (FIG. 4). The processor 12 may estimate the position of the apparatus 10 in Cartesian coordinates by converting the coordinates using trigonometric functions.

FIG. 5 schematically illustrates an example of a suitable transmitter apparatus 10. The apparatus 10 is mobile and comprises a processor 2 which is connected to at least read from a memory 6. It may also write to the memory 6. The processor 2 receives local atmospheric pressure measurements from a pressure sensor 4. The processor 2 controls a radio transmitter 12 to transmit the signal 50 for positioning the mobile apparatus 10.

The memory 6 stores a computer program 8 that controls the operation of the mobile apparatus 10.

The memory 6 and the computer program 8 are configured to, with the at least one processor 2, cause the apparatus 10 at least to transmit a signal 50 for positioning the apparatus 10, where the signal encodes the local atmospheric pressure measurement.

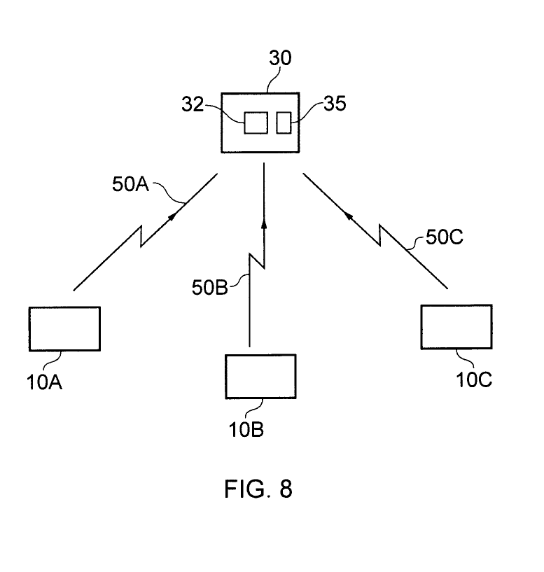

The method 40, may be adapted when diversity transmission is used. When diversity transmission is used, instead of having diverse antenna elements 32A, 32B, 32C which receive respective signals 50A, 50B, 50C from the same source apparatus 10, the apparatus 30, as schematically illustrated in FIG. 8, needs only one antenna element 32 which receives signals 50A, 50B, 50C from respective spatially diverse antenna elements of separate source transmitter apparatuses 10A, 10B, 10C.

When diversity transmission is used, the apparatus 30 is typically a mobile apparatus and the spatially diverse signals are provided by distinct base station apparatuses 10. That is, the diversity is provided by the infrastructure. The mobile apparatus 30 positions itself relative to the known location of the base station apparatuses 10.

In contrast, when diversity reception is used, the receiver apparatus 30 is typically a base station apparatus that is fixed. That is, the diversity is provided by the infrastructure. The apparatus 30 positions the apparatus 10 which is typically a mobile apparatus relative to the known location of the apparatus 30.

When diversity transmission is used, the method 40 is adapted. At block 41, signals 50A, 50B, 50C associated with multiple antenna elements 32A, 32B, 32C are received. However, rather than the radio signals 50A, 50B, 50C being received at multiple antenna elements 32A, 32B, 32C of the apparatus 30, the radio signals 50A, 50B, 50C are transmitted from spatially diverse apparatus 10A, 10B, 10C and received at the apparatus 30. One or more of the received signals 50A, 50B, 50C may encode an atmospheric pressure measurement made at a respective transmitter apparatus 10A, 10B, 10C.

The apparatus 30 uses the received signals and the generated constraint information to determine the position of the apparatus 30. It estimates a bearing for the apparatus 30 using the received signals as descried above for diversity reception. It estimates the constraint information using the atmospheric pressure measurement made at the pressure sensor 35 of the receiver apparatus 30. It estimates a position of the apparatus 30 using the estimated bearing and the constraint information.

The blocks illustrated in the FIG. 3 may represent steps in a method and/or sections of code in the computer program 13, 8. The illustration of a particular order to the blocks does not necessarily imply that there is a required or preferred order for the blocks and the order and arrangement of the block may be varied.

Although embodiments of the present invention have been described in the preceding paragraphs with reference to various examples, it should be appreciated that modifications to the examples given can be made without departing from the scope of the invention as claimed. For example, the apparatus 10 may not function as a mobile telephone. It may, for example, be a portable music player having a receiver for receiving radio signals.

Various examples of constraint information have been given in the preceding paragraphs, but the term “constraint information” it is not intended to be limited to these examples. The constraint information is based upon an atmospheric pressure measurement but main include additional constraints.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1-19. (canceled)

20. A method comprising:
receiving signals associated with multiple antenna elements;
determining constraint information based upon an atmospheric pressure measurement taken at an apparatus; and
using the received signals and the constraint information to determine the position of the apparatus, wherein the constraint information is dependent upon a ratio of a reference pressure and the taken pressure measurement.

21. A method as claimed in claim 20, wherein the constraint information is dependent upon one or more reference pressures and the taken pressure measurement.

22. A method as claimed in claim 20, wherein the reference pressure is a current atmospheric pressure measurement at a reference location.

23. A method as claimed in claim 20, wherein the constraint information is a height dependent upon the taken pressure measurement.

24. A method as claimed in claim 20, wherein the constraint information is dependent upon an atmosphere model and the taken pressure measurement.

25. A method as claimed in claim 24, wherein the atmosphere model is updated via received data.

26. A method as claimed in claim 24, wherein receiving signals associated with multiple antenna elements comprises receiving at the multiple antenna elements at a receiver a signal transmitted from the apparatus.

27. A method as claimed in claim 24, wherein using the received signals and the constraint information to determine the position of the apparatus comprises:
estimating a bearing of the apparatus from the receiver using the received signals; and
estimating a position of the apparatus using the estimated bearing and the constraint information.

28. A method as claimed in claim 27, wherein the multiple antenna elements are antenna elements of a ceiling mounted antenna array.

29. A method as claimed in claim 26, wherein receiving signals associated with multiple antenna elements comprises receiving at the apparatus multiple signals transmitted from respective multiple antenna elements at different locations.

30. A method as claimed in claim 27, wherein using the received signals and the constraint information to determine the position of the apparatus comprises:
estimating a bearing for the apparatus using the received signals;
estimating a position of the apparatus using the estimated bearing and the constraint information.

31. A method as claimed in claim 27, wherein the received radio signals are beacon signals.

32. An apparatus comprising:
at least one processor; and
at least one memory including computer program code
the at least one memory and the computer program code configured to, with the at least one processor, cause the apparatus at least to:
determine constraint information based upon an atmospheric pressure measurement taken at an apparatus, wherein the constraint information is dependent upon a ratio of a reference pressure and the taken pressure measurement; and
use received signals associated with multiple antenna elements
and the constraint information to determine the position of the apparatus.

33. An apparatus as claimed in claim 32 wherein the at least one memory and the computer program code are configured to, with the at least one processor, cause the apparatus at least to perform the method of claim 32.

34. An apparatus comprising:
means for receiving signals associated with multiple antenna elements;
means for determining constraint information based upon an atmospheric pressure measurement taken at an apparatus;
means for using the received signals and the constraint information to determine the position of the apparatus, wherein the constraint information is dependent upon a ratio of a reference pressure and the taken pressure measurement.

35. A computer program which when loaded into a processor enables the processor to:
determine constraint information based upon an atmospheric pressure measurement taken at an apparatus, wherein the constraint information is dependent upon a ratio of a reference pressure and the taken pressure measurement; and
use received signals associated with multiple antenna elements
and the constraint information to determine the position of the apparatus.

36. An apparatus comprising:
a pressure sensor configured to take a local atmospheric pressure measurement;
a transmitter configured to transmit a signal for positioning the apparatus, the signal encoding the local atmospheric pressure measurement.

37. A system comprising:
an apparatus
A computer program which when loaded into a processor enables the processor to:
determine constraint information based upon an atmospheric pressure measurement taken at an apparatus, wherein the constraint information is dependent upon a ratio of a reference pressure and the taken pressure measurement; and
use received signals associated with multiple antenna elements
and the constraint information to determine the position of the apparatus and
an apparatus wherein the at least one memory and the computer program code are configured to, with the at least one processor, cause the apparatus at least to perform the method of determining constraint information based upon an atmospheric pressure measurement taken at an apparatus, wherein the constraint information is dependent upon a ratio of a reference pressure and the taken pressure measurement; and
using received signals associated with multiple antenna elements
and the constraint information to determine the position of the apparatus.

38. A computer product comprising computer executable program code on a computer readable non-transitory medium, the computer executable program code comprising:
code for perform the method of determining constraint information based upon an atmospheric pressure measurement taken at an apparatus, wherein the constraint information is dependent upon a ratio of a reference pressure and the taken pressure measurement; and
using received signals associated with multiple antenna elements
and the constraint information to determine the position of the apparatus.
